(19) United States
(12) Patent Application Publication
(10) Pub. No.: US 2006/0169750 A1
(43) Pub. Date: Aug. 3, 2006

(54) Soldering method and apparatus

(75) Inventors: Hisao Tanaka, Kawasaki (JP); Masanao Fujii, Kawasaki (JP); Toru Okada, Kawasaki (JP); Susumu Iida, Kawasaki (JP); Hirokazu Yamanishi, Kawasaki (JP); Yutaka Noda, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/139,789

(22) Filed: May 31, 2005

(30) Foreign Application Priority Data
Jan. 31, 2005 (JP) 2005-022775

(51) Int. Cl. B23K 1/005

(52) U.S. Cl. 228/205; 228/214; 219/121.64

(57) ABSTRACT

There are provided a solder ball deforming step of mechanically deforming a ball to break an oxide film of a surface thereof and to expose a nonoxide surface and a solder melting step of heating and melting the deformed solder ball through energy irradiation in a state where the deformed solder ball is mounted on joint units of a loaded work. The solder ball deforming step mechanically deforms the solder ball to form at least two orthogonal contact surfaces in contact with the joint surfaces of the joint units.

This application is a priority based on prior application No. JP 2005-22775, filed Jan. 31, 2005, in Japan.

### BACKGROUND OF THE INVENTION

1. Field of the Invention

The present invention relates to a soldering method and apparatus for soldering works by using a fine solder ball, and particularly to a soldering method and apparatus for soldering works by using a low-melting-point solder ball instead of using a flux.

2. Description of the Related Arts

Conventionally, a head gimbals assembly which is a constituent of a hard disk mounts thereon a slider which mounts a head on a suspension mounted on a tip of an arm driven by a voice coil motor, and an Au—Au ultrasonic jointing method using platinum is used for electrically jointing and fixing the suspension and the slider. In the Au ultrasonic jointing method, a head called capillary is directly pressed on an Au jointing potion and a mechanical ultrasonic vibration is applied thereto to joint the same. However, since the Au ultrasonic jointing method applies the mechanical ultrasonic vibration to joint the joint unit, there are problems that a residual stress remains on the jointing and the jointing may release across the ages and that material and equipment costs are high. On the other hand, there has been known a soldering method for electrically jointing and fixing the suspension and the slider. However, soldering connection generally requires to use a flux for securing solder wettability. Thus, when the soldering method is used, a step of removing (cleansing) flux residuals remaining after the soldering has to be added. If the cleansing is not complete, there is a possibility that a failure such as head crash due to the flux residuals occurs, and it is necessary to construct a cleansing process having a sufficient margin. In order to solve the problems of the soldering method using such flux, there has been proposed a fluxless soldering method for performing soldering instead of using a flux. For example, in a soldering method in patent reference 1, solder bumps are formed on an end pad of a conductive lead of a suspension and a contact pad of a slider, respectively, by soldering using a flux in the pre-step before assembly. In the soldering in the assembling step, the solder bump attached on the end pad of the suspension is heated and fused while nitrogen gas is being flowed in a state the solder bump attached on the contact pad of the slider is contacted or approximately arranged thereto. In a soldering method in patent reference 2, a fine solder ball is supplied by a capillary tube to the pad of the slider oppositely arranged to the pad of the suspension to hold the same light due to flow-out of the nitrogen gas, and a laser beam is irradiated on the solder ball from the opening through the capillary tube in this state to reflow the solder ball.
[Patent Reference 1] Japanese Patent Application Laid-Open No. 7-320434
[Patent Reference 2] Japanese Patent Application Laid-Open No. 10-079105
[Patent Reference 3] Japanese Patent Application Laid-Open No. 2002-203872

However, the conventional fluxless soldering method has the following problems. In the soldering method in patent reference 1, there are various problems that the pre-step of previously forming the solder bumps in the end pad of the suspension and the contact pad of the slider, respectively, is required, that equipment cost of the pre-step is high, and that accurate size and shape of the solder bumps are required to control so that working of the pre-step is complicated. Since heat energy of about 400 mJ is required in heating and fusing a solder bump, a YAG laser having large power is used and there is a problem that the laser is made larger and equipment cost becomes higher. On the other hand, in the soldering method in patent reference 2, since the surface of the solder ball is covered with an oxide film and a flux is not used, there is a problem that solder wettability is deteriorated when irradiating a laser beam and reflowing the solder ball and the solder may be released from the pad due to the residual stress after cooling, which lowers reliability. Further, since a Nd:YAG laser having large power is used for reflowing the solder, there is a problem that the laser is made larger and equipment cost becomes higher.

### SUMMARY OF THE INVENTION

According to the present invention, there are provide a soldering method and apparatus for securing solder wettability and accurately fusing instead of using a flux.

The present invention is constituted as follows in order to achieve the object. The present invention provides a fluxless soldering method which does not use a flux. The soldering method according to the present invention is characterized by comprising:

a solder ball deforming step of mechanically deforming a ball to break an oxide film of a surface thereof and to expose a nonoxide surface; and

a solder melting step of heating and melting a deformed solder ball through energy irradiation in a state where the deformed solder ball is mounted on joint units of a loaded work.

Here, the solder ball deforming step mechanically deforms the solder ball to form contact surfaces in contact with joint surfaces of the joint units.

The solder ball deforming step mechanically deforms the solder ball to form at least two orthogonal contact surfaces in contact with the joint surfaces of the joint units.

The solder ball deforming step comprises:

a first deforming step of sandwiching and deforming a solder ball from both sides thereof to process the same into a tire shape; and

a second deforming step of deforming in a direction orthogonal to the processing direction in the first deforming step to form two orthogonal contact surfaces in contact with the joint surfaces of the joint units.

The soldering method according to the present invention provides an applying step of applying a tacking agent on joint units of a loaded work as a pre-step of the solder ball deforming step. The tacking agent is a liquid agent which temporarily fixes the solder ball and has a boiling point close to a melting point of the solder ball. For example, the tacking agent includes alcohol or water. Polyalcohol including glycerin or 1-butanol is preferable.

The solder melting step fills inert gas such as nitrogen in an atmosphere of the joint unit. The solder melting step mixes reducing gas containing hydrogen gas or chlorine gas into the inert gas which fills the atmosphere of the joint unit.

The solder melting step irradiates light energy or thermal energy near the joint units of the work and pre-heats the work itself immediately before the laser beam irradiation for melting the solder ball.

The solder melting step irradiates a laser beam from a semiconductor laser on a rear surface of the work and pre-heats the work immediately before melting a solder ball by the laser beam from the semiconductor laser.

The solder ball is a low-melting-point solder. The low-melting-point solder is a low-melting-point lead-free solder including Sn-57Bi, Sn-56Bi-1Ag, or Sn-52In.

In the soldering method according to the present invention, the work is a suspension mounting a slider thereon, and a pad formed in the suspension and a pad formed in the slider are electrically jointed.

The present invention provides a fluxless soldering apparatus which does not use a flux. The soldering apparatus according to the present invention is characterized by comprising a solder ball deforming unit for mechanically deforming a solder ball to break an oxide film of a surface thereof and to expose a nonoxide surface, and a solder melting unit for heating and melting a deformed solder ball through irradiation of light energy in a state where the deformed solder ball is mounted on joint units of a loaded work.

Details of the soldering apparatus are basically identical to those of the soldering method according to the present invention. In other words, each step in the soldering method is provided as each unit. According to the present invention, for example, respective pads of a suspension of a head gimbals assembly in a hard disk drive and a slider can be finely jointed by giving an external force to a solder ball and mechanically deforming the same immediately before the jointing to break an oxide film of the surface thereof and by rapidly heating the joint unit through light energy irradiation instead of using a flux in a state where excellent solder wettability is secured instead of using a flux. Since the solder ball is mechanically deformed to have contact surfaces in contact with the respective pads orthogonally arranged, and the low-melting-point solder is used, heat which has been generated by low-power light energy irradiation can be efficiently conducted to the solder ball and the pads, thereby reducing the light energy required for the soldering, enabling to use a semiconductor laser, and remarkably reducing equipment cost. The above and other objects, features, and advantages of the present invention will become more apparent from the following detailed description with reference to the drawings.

### BRIEF DESCRIPTION OF THE DRAWINGS

FIG. 1 is an explanatory diagram of processing steps of a soldering method according to the present invention;

FIG. 2 is an explanatory diagram of an embodiment of a soldering apparatus according to the present invention;

FIG. 3 is an explanatory diagram of processing steps of the soldering apparatus in FIG. 2;

FIGS. 4A and 4B are explanatory diagrams of a first deforming step in a solder ball deforming step according to the present invention;

FIGS. 5A and 5B are explanatory diagrams of a second deforming step subsequent to FIGS. 4A and 4B;

FIGS. 6A and 6B are explanatory diagrams of a processed state where the solder ball deformation is completed;

FIGS. 7A and 7B are explanatory diagrams of a deformed solder ball processed in the deforming steps in FIGS. 4 to 6; and

FIGS. 8A to 8D are explanatory diagrams of an alcohol applying step, a solder ball mounting step, and a solder ball melting step according to the present invention by way of an example where a suspension in a head gimbals assembly used in a hard disk drive and a slider are jointed.

### DETAILED DESCRIPTION OF THE PREFERRED EMBODIMENTS

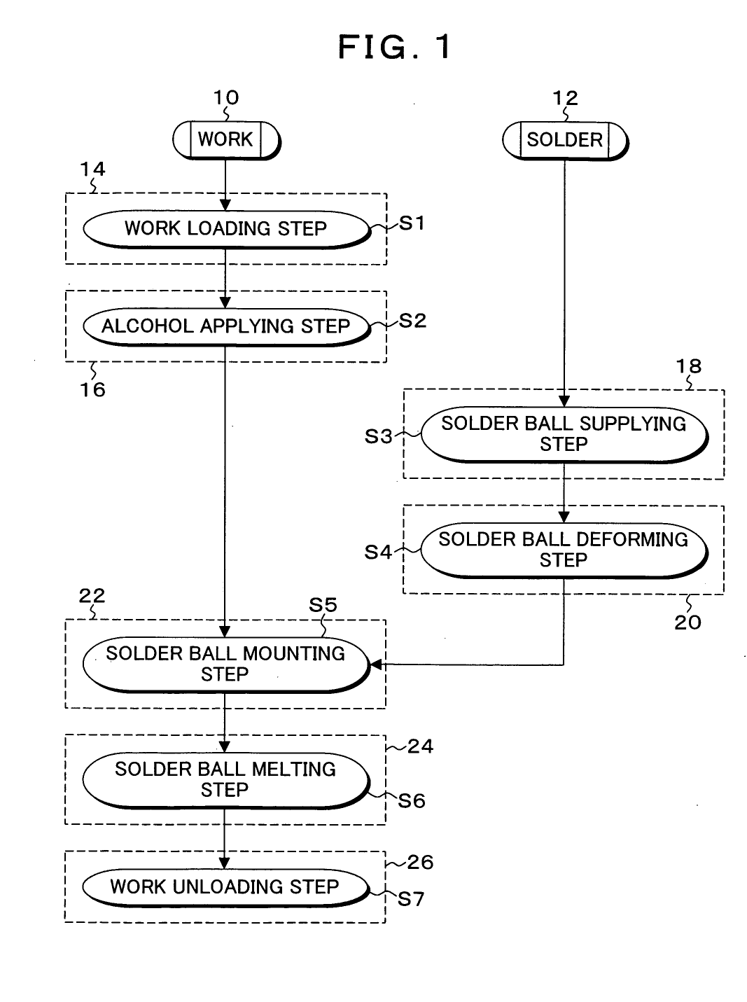

FIG. 1 is an explanatory diagram of processing steps in a soldering method according to the present invention. In FIG. 1, the soldering method according to the present invention is constituted of a work loading step S1, an alcohol applying step S2, a solder ball supplying step S3, a solder ball deforming step S4, a solder ball mounting step S5, a solder ball melting step S6, and a work unloading step S7 in the order of the steps. There are provided, as units corresponding to these steps, a loading unit 14, an alcohol applying unit 16, a solder ball supplying unit 18, a solder ball deforming unit 20, a solder ball mounting unit 22, a solder ball melting unit 24, and an unloading unit 26, and the combination of these units constitutes a soldering apparatus according to the present invention. In the work loading step S1, the loading unit 14 uses roller carrying to load a work in the soldering apparatus. In the present invention, as will be clear in the later explanation, there is exemplified, as the work to be soldered, a work which mounts a slider on a tip of a suspension in a head gimbals assembly of a hard disk drive and is soldered. In the alcohol applying step S2, the alcohol applying unit 16 using a dispense system or the like is used to apply a slight amount of alcohol on a portion of the work to be soldered. The alcohol applying position at this time is corrected by detecting a position of the joint unit by a camera recognizing processing while a slight amount of alcohol is accurately applied on the joint unit. The alcohol applying is performed for temporarily fixing a solder ball on an Au pad which is to be a soldering unit of the work. The applying of a slight amount of alcohol, which is used for temporarily fixing the solder ball, utilizes a tacking force of the applied alcohol to temporarily fix the solder ball on the pad. For volatile removal in solder melting, alcohol.whose boiling point is close to a melting point of the solder to be used for soldering is suitable as the alcohol used to temporarily fix the solder ball. In the present invention, as will be clear in the later explanation, since a low-melting-point solder ball is used and its melting point is in the range from 110 to 150°, glycerin or 1-butanol which is polyalcohol is suitable as the alcohol used to temporarily fix the solder ball. A liquid agent for temporarily fixing the solder ball may use water instead of alcohol. Since the boiling point of water is 100°, the water can be accurately removed by evaporation and volatility in solder melting. On the other hand, a processing for a solder 12 is performed in parallel with a processing for a work 10. In the processing for the solder 12, solder balls are cut out one by one by the solder ball supplying unit 18 in step S3, and an absorption nozzle is used to carry the cut-out solder balls to the solder ball deforming step S4 in the next solder ball deforming unit 20. The solder ball used for the soldering according to the present invention uses a low-melting-point solder. For example, a low-melting-point lead-free solder such as Sn-57Bi having a melting point of 139°, Sn-56Bi-1Ag, or Sn-52In having a melting point of 117° is employed. Such low-melting-point solder is used, thereby preventing an influence on a work due to heating in the soldering and a deformation stress when the solder is cooled and fixed. In other words, the deformation stress in the solder fixing in the soldering is in the relationship that when the temperature difference ΔT between the melting point and the ordinary temperature after cooling is larger, the amount of solder contraction becomes larger and the deformation stress becomes larger. Thus, the low-melting-point solder is used, thereby reducing the temperature difference ΔT between the melting point and the ordinary temperature, restricting the deformation stress in the solder fixing, and preventing an influence on a work. Further, the low-melting-point solder is used, thereby reducing light energy for the solder melting and enabling to use a semiconductor laser. In the solder ball deforming step S4 by the solder ball deforming unit 20, the solder ball is mechanically deformed to break an oxide film of the surface thereof and to expose a nonoxide film to the outside. The oxide film of the surface of the solder ball is broken by the mechanical deformation, thereby accurately securing solder wettability in the soldering instead of using a flux. In the solder ball deforming according to the present invention, as will be clear in the later explanation, the solder ball is sandwiched by a mold block in two stages so that contact surfaces are processed and formed on the pads orthogonally arranged on the work such that the deformed solder ball is contacted therewith with its surface. Thus, the contact area between the deformed solder ball and the pads of the joint units is accurately secured, which enables to easily make contact between a portion without an oxide film caused by the broken surface due to the deforming or a thin portion on the oxide film and the pads to be jointed, thereby enabling the soldering with accurately secured solder wettability instead of using a flux. Since the deformed solder ball is contacted on the pads with the sufficient contact area, as will be clear in the later explanation, when a laser beam is irradiated on the deformed solder ball to heat the same, it is possible to heat the deformed solder ball and to efficiently conduct the heat to the pads and to heat the same, and the deformed solder ball and the pads to be soldered can be efficiently heated, thereby securing higher solder wettability. The soldering is a phenomenon that metals to be soldered, for example, Au are mutually contacted in a pure state without foreign materials and are combined by diffusion of the metals and generation of a metal compound. The foreign material in this case is an oxide film on the solder surface. Since Au forming the pad is not oxidized, the oxide film on the solder is broken due to the mechanical deformation of the solder ball, which enables to solder with secured solder wettability. Subsequently, the solder ball mounting unit 22 performs the solder ball mounting step S5. In this solder ball mounting step S5, the solder ball deformed in the solder ball deforming step S4 is subjected to handling by using an absorption nozzle and is positioned by the camera recognition to be mounted on the joint unit on the work. Subsequently, the solder ball melting unit 24 performs the solder ball melting step S6. In this solder ball melting step S6, a laser beam is irradiated to melt the solder and to complete the soldering. The solder ball melting unit 24 surrounds the periphery of the work in a box shape, fills nitrogen gas N₂ as inert gas therein to reduce the oxygen concentration, and restricts the oxide film formation on the solder surface in laser heating to perform the soldering. When reducing gas such as halogen gas containing hydrogen or chlorine is mixed into the inert gas at the same time with the filling of the inert gas such as nitrogen, the oxide film may be chemically reduced in heating to further enhance the solder wettability similarly as in using a flux. The laser unit used in the solder ball melting step S6 according to the present invention may use a semiconductor laser. Though the semiconductor laser has lower power than a conventional YAG laser, in the present invention, a work is pre-heated (preliminarily heated) immediately before the soldering, which enables to use the semiconductor laser. In this embodiment, a laser beam from the semiconductor laser is irradiated on the rear surface of the work to pre-heat the same immediately before the soldering, for example. Finally, in the work unloading step S7 using the unloading unit 26, the work is extracted from the soldering apparatus to terminate the processing.

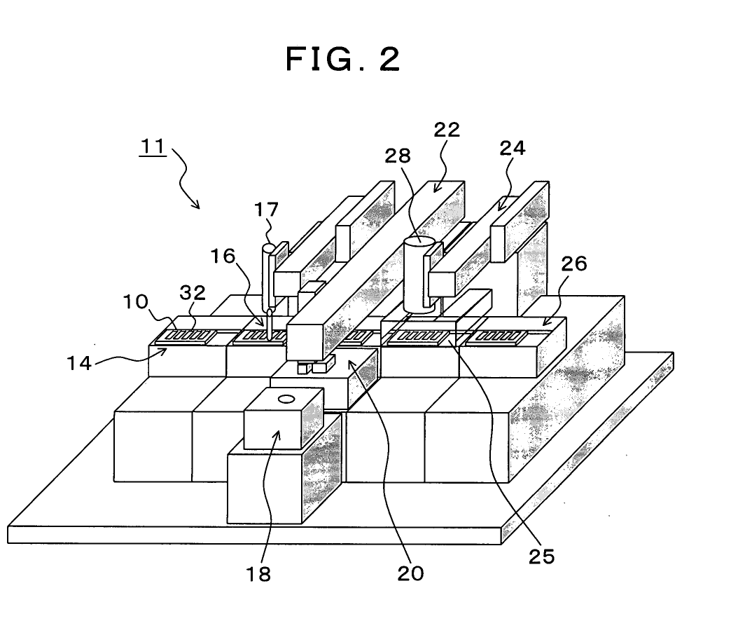

FIG. 2 is an explanatory diagram of an embodiment of the soldering apparatus according to the present invention. In FIG. 2, a soldering apparatus 11 arranges therein, from a carrying inlet of the work, the loading unit 14, the alcohol applying unit 16, the solder ball mounting unit 22, the solder ball melting unit 24, and the unloading unit 26, and on the other hand, the solder ball supplying unit 18 and the solder ball deforming unit 20 are arranged for the solder ball mounting unit 22. The loading unit 14 uses roller carrying to load the work 10 in the soldering apparatus 11. For example, five suspensions mounting thereon a slider to be soldered, which will be clear in the later explanation, are mounted on the works 10, respectively. The alcohol applying unit 16 applies, by the dispenser 17, a slight amount of alcohol on the joint unit on which the Au pad is arranged in the suspension on the work 10 loaded by the loading unit 14. The applying position in this case is positioned and corrected by the camera recognition. On the other hand, the solder ball supplying unit 18 extracts solder balls having a diameter of, for example, about 0.1 to 0.2 mm one by one and carries the same to the solder ball deforming unit 20. The solder ball deforming unit 20 deforms the solder ball through two-stage mechanical deformation using a mold. The deformed solder ball is handled using the absorption nozzle by the solder mounting unit 22, and is mounted on the pad of the joint unit on which a slight amount of alcohol is applied by the alcohol applying unit 16 to be temporarily fixed by the tacking force of the applied alcohol. Also in the mounting of this deformed solder ball, the solder ball is positioned on the soldering unit by camera recognition and is accurately mounted. The solder ball melting unit 24 irradiates a laser beam from the laser unit 28 using the semiconductor laser on the joint unit on which the deformed solder ball is temporarily fixed, and heats and melts the same to complete the soldering. The laser beam from the laser unit 28 is irradiated on the rear surface of the work to pre-heat the same immediately before heating and melting the solder. The work in the solder ball melting unit 24 is arranged in a case 25, and the solder is melted in the state where nitrogen gas N₂ is filled in the case 25 and the oxygen concentration is reduced. The work on which the solder is melted and fixed in the solder ball melting unit 24 is extracted to the outside by the unloading unit 26 and a series of soldering processings is terminated.

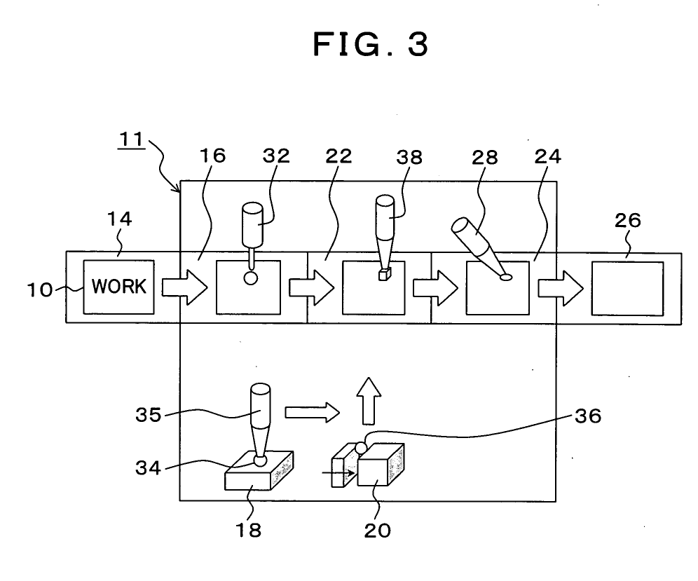

FIG. 3 shows processing steps by the soldering apparatus 11 in FIG. 2 in a planar manner. In FIG. 3, after the work 10 is loaded on the apparatus by the loading unit 14 and a slight amount of alcohol is applied on the joint unit by an alcohol spraying unit 32, the work 10 is carried to the solder mounting unit 22. The solder balls 34 extracted one by one from the solder ball supplying unit 18 are deformed in two stages in the solder ball deforming unit 20 to produce deformed solder balls 36. The deformed solder ball is positioned and mounted on the joint unit on the work by an absorption nozzle 38 and is temporarily fixed by the tacking force of the applied alcohol. Subsequently, the deformed solder ball is carried to the solder ball melting unit 24. After the work is first pre-heated, the solder is melted by the irradiation of the laser beam from the laser unit 28 to complete the soldering, and the work is finally extracted to the outside by the unloading unit 26.

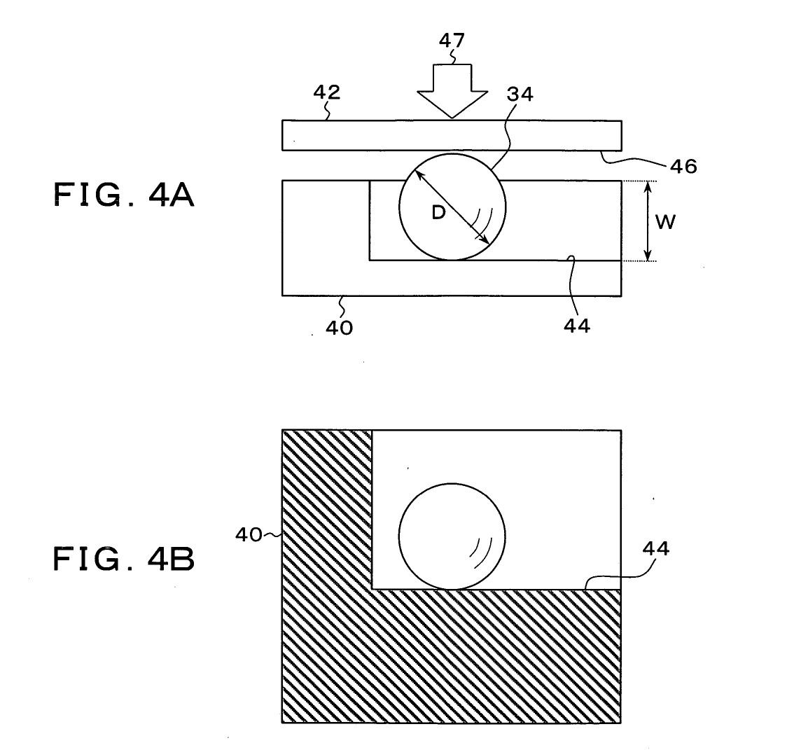

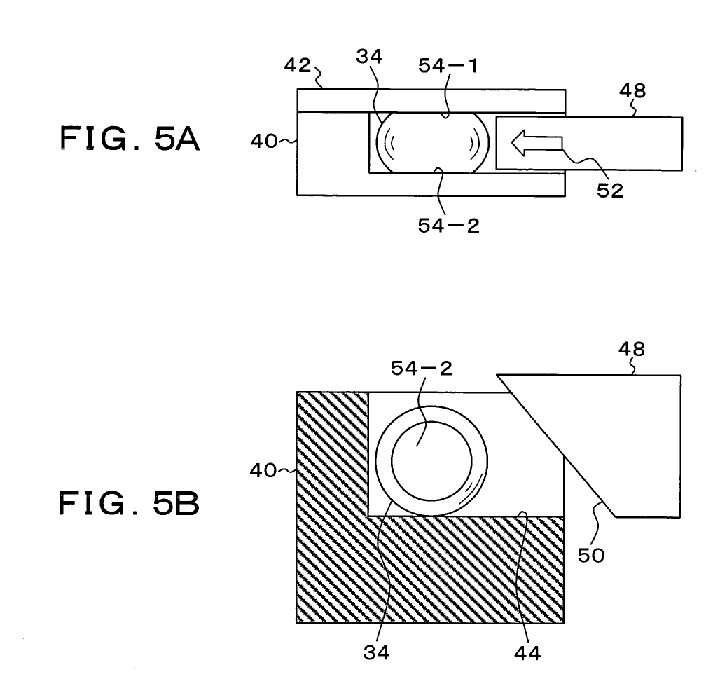

FIGS. 4A and 4B are explanatory diagrams of a first deforming step in the solder ball deforming step according to the present invention. FIG. 4A is a plan view and FIG. 4B is a cross-sectional view viewed in the lateral direction thereof. In the first deforming step in FIGS. 4A and 4B, a ball accommodating unit 44 which is hollowed in a rectangular shape is formed in a fixing mold 40, and the solder ball 34 is arranged therein, and a pressing mold 42 is laterally driven as shown by an arrow 47, and the solder ball 34 is pressed from both sides and is mechanically deformed into a tire shape as shown in FIGS. 5A and 5B. Here, the ball accommodating unit 44 has a width W, which is smaller than a diameter D of the solder ball 34, and the deforming for collapsing the solder ball 34 is performed in the lateral direction by (D-W).

FIGS. 5A and 5B are explanatory diagrams of a second deforming step subsequent to FIGS. 4A and 4B. In FIGS. 5A and 5B, another pressing mold 48 which forms a taper pressing surface 50 on the tip from the right opening of the ball accommodating unit 44 is pushed in the lateral direction of an arrow 52 to mechanically deform the solder ball in a direction orthogonal to the processing direction of the deforming surfaces 54-1 and 54-2 in the state where the solder ball 34 is pressed by the pressing mold 42 against the fixing mold 40 to form the deforming surfaces 54-1 and 54-2 on both sides thereof in the first deforming step.

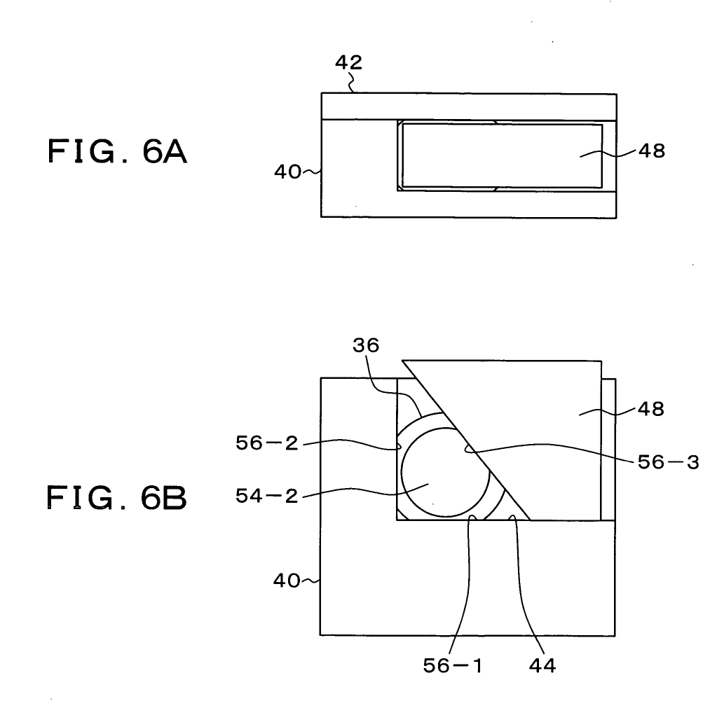

FIGS. 6A and 6B are explanatory diagrams of a processed state where the solder ball deforming step in the second deforming step is completed, where the deformed solder ball 36 is pressed against a corner of the solder accommodating unit 44 through the pressing of the pressing mold 48 to form the contact surfaces 56-1 and 56-2 orthogonal to downward and laterally, and at the same time a spherical unit obliquely upward from the taper pressing surface 50 is collapsed to form a taper deforming surface 56-3.

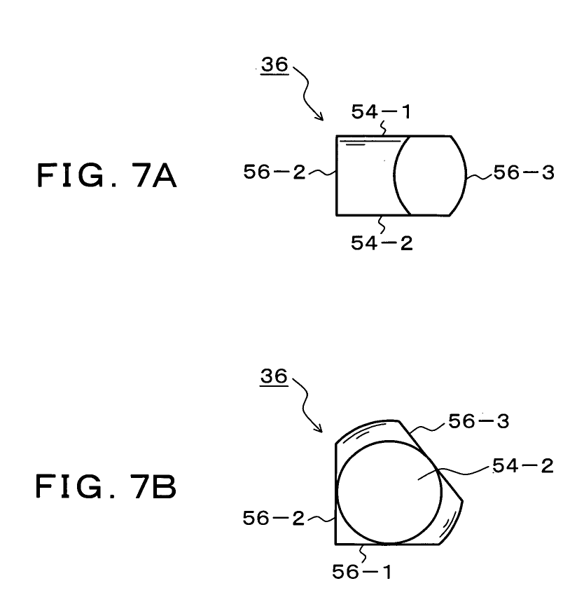

FIGS. 7A and 7B are explanatory diagrams of the deformed solder ball 36 used in the present invention, which is processed in the deforming steps in FIGS. 4 to 6. In the deformed solder ball 36 obtained by the two-stage deforming, the oxide film of the surface of the solder ball is broken due to the two-stage deforming, and the oxide film on the portion whose oxide film has not been broken is thin caused by the elongation of the surface due to the deforming, and particularly the oxide film of the surface in the contact surfaces 56-1 and 56-2, which are deformed in a plan state from the spherical state through the pressing of the mold, is sufficiently broken and exposed, and the oxide film of other portion is sufficiently thin. This is similar to the taper deforming surface 56-3 or the deforming surfaces 54-1 and 54-2 formed in the first deforming. As a result, when the deformed solder ball 36 is melted through the irradiation of the laser beam instead of using a flux, the oxide film as foreign material can be restricted to the minimum in the contact surfaces with the Au pads to be soldered, thereby securing the solder wettability and accurately soldering.

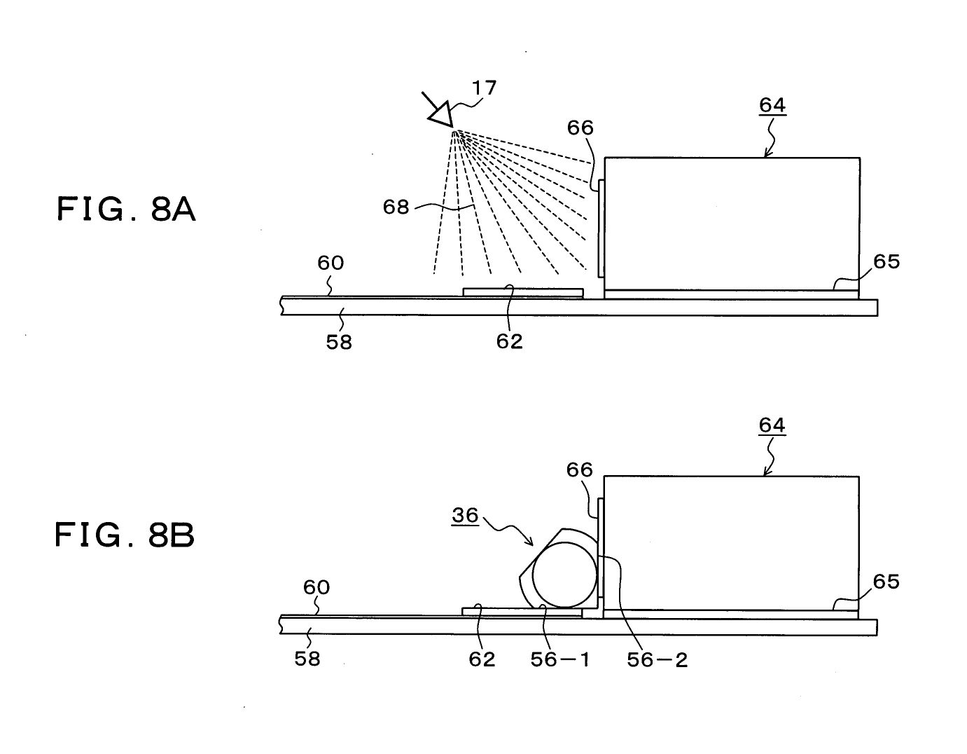

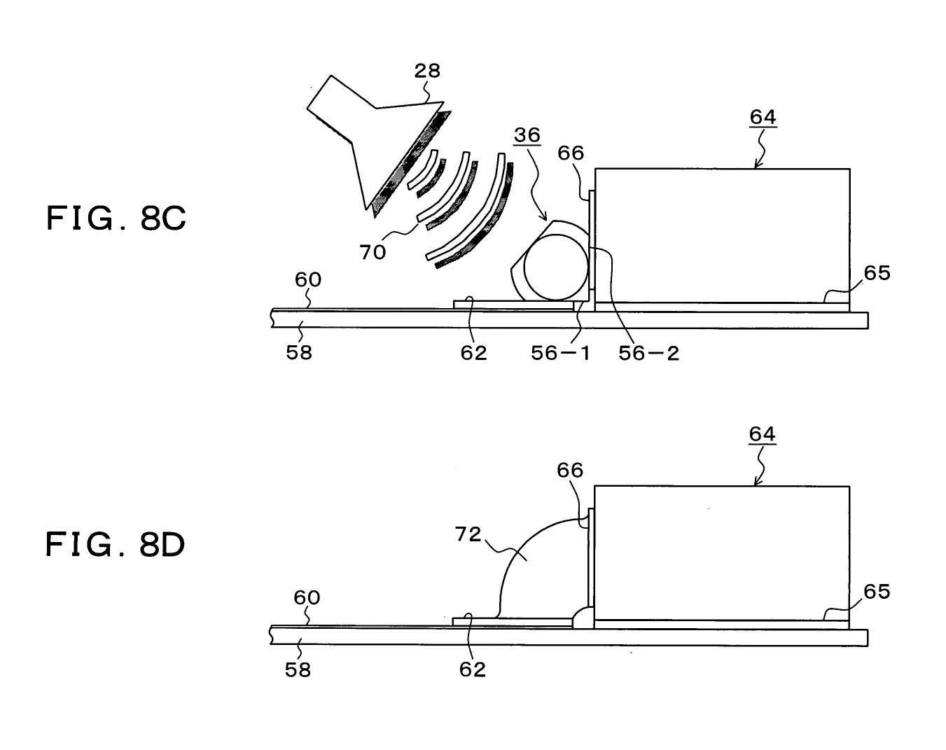

FIGS. 8A to 8D explain the alcohol applying step, the solder ball mounting step, and the solder ball melting step according to the present invention by way of an example where a slider mounted on a suspension of a head gimbals assembly used in a hard disk drive is soldered.

FIG. 8A shows the alcohol applying step, where a suspension 58 in the head gimbals assembly forms a solder lead 60 on the surface thereof via an insulating layer and forms a pad 62 using Au on the tip of the solder lead 60. A slider 64 mounting thereon a complex head element of light head and lead head is fixed on the tip of the suspension 58 by a fixing layer 65, and a pad 66 using Au for electrically connecting with the complex head is formed on an end surface of the conductive lead 60 of the slider 64. In the alcohol applying step, a slight amount of alcohol 68 is applied to the pads 62 and 66 by the dispenser 17 for the slider 64 mounted on such suspension 58.

FIG. 8B shows the solder ball mounting step. The deformed solder ball 36 shown in FIGS. 7A and 7B, which has been obtained in the solder ball deforming step, is positioned and mounted on the pad 62 of the suspension 58 and the pad 66 of the slider 64, and the deformed solder ball 36 is temporarily fixed by the tacking force of the alcohol since the alcohol applying has been performed on the pads 62 and 66 at this time. The deformed solder ball 36 is arranged such that the orthogonal contact surfaces 56-1 and 56-2 are in surface-contact with the pad 62 of the suspension 58 and the pad 66 of the slider 64, which are similarly arranged orthogonally to each other.

FIG. 8C shows the solder ball melting step. A laser beam 70 is irradiated from the laser unit 28 on the deformed solder ball 36 temporarily fixed on the pads 62 and 66 to heat the same, so that the deformed solder ball 36 is melted. With respect to the heating temperature by the irradiation of the laser beam 70, since the low-melting-point solder is used as the deformed solder ball 36, the solder is heated at a temperature slightly higher than the melting point thereof so that the solder can be fused. When Sn-52In is used as the low-melting-point solder, for example, since the melting point thereof is 117°, the power of the laser beam 70 may be set and irradiated such that the temperature thereof exceeds this melting point. The heating temperature by the irradiation of the laser beam 70 is determined by the power of the laser beam and the irradiating time. The deformed solder ball 36 is contacted with the pads 62 and 66 with the sufficient contact area by the formation of the orthogonal contact surfaces 56-1 and 56-2, and the pads 62 and 66 can be efficiently heated through the heat conduction while the deformed solder ball 36 is heated, thereby accurately performing soldering. In the orthogonally arranged contact surfaces 56-1 and 56-2 in contact with the pads 62 and 66 of the deformed solder ball 36, the oxide films of the surfaces are broken or made thin during the deforming immediately before the soldering and are heated in the atmosphere of inert gas or the like. Thus, it is possible to restrict the presence of the oxide film as foreign material in the pads 62 and 66 to the minimum and to secure sufficient wettability for soldering instead of using a flux. In the solder ball melting step in FIG. 8C, the deformed solder ball 36 is heated and melted to be soldered by the irradiation of the laser beam 70 from the laser unit 28 using the semiconductor laser, but it is desirable to pre-heat the work itself for further enhancing the solder wettability. The pre-heating of the work utilizes the characteristic that the solder easily moves to a portion having a higher temperature in melting, thereby enhancing the solder wettability. In order to pre-heat the work, light energy such as laser beam, xenon light, halogen light may be irradiated on the top or the bottom of the work immediately before the soldering, or a heat ray may be added thereto by an infrared heater to heat the work itself. In the present invention, the semiconductor laser having low power is used as the laser unit 28 to perform pre-heating and solder melting. The soldering conditions using the semiconductor laser according to the present invention are as follows:

(A) Pre-heating through irradiation on the bottom at 0.5W and for 6.0 seconds;

(B) Melting through irradiation on the top at 1.4W and for 0.5 seconds. On the contrary, the condition is as follows when the conventional YAG laser is used for the same work to perform solder melting instead of pre-heating:

(C) At 6.75W and for 0.02 seconds

In the case of the YAG laser, since the soldering is performed for a short time and at high output, distortion remains on the solder and creases also remain on the solder surface. Since the solder originally melts and flows to spread to the electrodes in the soldering, a certain degree of time is required. Thus, since the irradiating time is too short and melting is not performed for a sufficient time in the YAG laser, it is difficult to secure the residual of the inner stress and the solder wettability. On the contrary, since the semiconductor laser is used in the present invention so that the solder melts and flows to spread to the electrodes, the solder can be melted over a required time, thereby reducing the residual inner stress and securing the solder wettability. With-respect to the timings of the pre-heating through the irradiation on the bottom by the laser beam and the melting through the irradiation on the top by the laser beam, the solder melting may be performed immediately after the pre-heating, or the solder melting may be performed in overlapping with the end timing of the pre-heating. In the melting step in FIG. 8C, the solder is melted in the atmosphere where nitrogen gas N₂ as the inert gas is filled, but the oxygen concentration which causes to oxidize the metal surface of the solder or the electrode is managed in this case. In the general SMT reflow soldering, it is clear that the characteristics change at the oxygen concentration of 1000 ppm or less and the solder wettability is enhanced. Further, the oxygen concentration is managed to be 1000 to 3000 ppm or about 100 ppm in consideration of the nitrogen cost. From these requirements, it is experientially preferable that the inert gas is filled so that the oxygen concentration is 5000 ppm or less in the present invention. The lower limit of the oxygen concentration is assumed to be 10 ppm. In the case of the apparatus for loading and unloading the work as in the embodiment according to the present invention, it is substantially difficult to operate the apparatus at the oxygen concentration therebelow as far as a special sealed structure is not employed. Further, when nitrogen N₂ as the inert gas is filled and reducing gas such as halogen gas containing hydrogen or chlorine is mixed, the oxide film is chemically reduced in heating to further enhance the solder wettability similarly as in using a flux. In this case, the concentration of the reducing gas such as hydrogen or chlorine, which is mixed into the inert gas, is about 10 to 1000 ppm in order to secure the active force in consideration of dangerousness and toxicity.

FIG. 8D is an explanatory diagram of the suspension 58 whose soldering has been completed, where the pad 62 of the suspension 58 and the pad 66 of the slider 64 are fused by the solder 72. The above embodiment exemplifies the soldering of the slider mounted on the suspension of the head gimbals assembly in the hard disk drive, but the present invention is not limited thereto and can be applied to appropriate works for soldering Au-plated pads using a fine solder ball. The above embodiment exemplifies the two-stage deforming using the mold for the solder ball deforming, but any deforming may be employed as far as the deforming is mechanically performed so that the oxide film of the solder ball surface is broken, and the contact surfaces due to the deformation of the solder ball are deformed to have an appropriate shape depending on the arrangement or the shape of the pads constituting the joint units to be soldered. The present invention includes appropriate modifications without losing the object and advantages thereof, and is not limited by the numeric values shown in the above embodiment.

1. A soldering method comprising:
a solder ball deforming step of mechanically deforming a ball to break an oxide film of a surface thereof and to expose a nonoxide surface; and
a solder melting step of heating and melting a deformed solder ball through irradiation of light energy in a state where the deformed solder ball is mounted on joint units of a loaded work.

2. The soldering method according to claim 1, wherein the solder ball deforming step mechanically deforms the solder ball to form contact surfaces in contact with joint surfaces of the joint units.

3. The soldering method according to claim 1, wherein the solder ball deforming step mechanically deforms the solder ball to form at least two orthogonal contact surfaces in contact with the joint surfaces of the joint units.

4. The soldering method according to claim 1, wherein the solder ball deforming step comprises:
a first deforming step of sandwiching and deforming a solder ball from both sides thereof to process the same into a tire shape; and
a second deforming step of deforming in a direction orthogonal to the processing direction in the first deforming step to form two orthogonal contact surfaces in contact with the joint surfaces of the joint units.

5. The soldering method according to claim 1, wherein an applying step of applying a tacking agent on joint units of a loaded work is provided as a pre-step of the solder ball deforming step.

6. The soldering method according to claim 5, wherein the tacking agent is a liquid agent which temporarily fixes the solder ball and has a boiling point close to a melting point of the solder ball.

7. The soldering method according to claim 5, wherein the tacking agent includes alcohol or water.

8. The soldering method according to claim 7, wherein the alcohol is polyalcohol containing glycerin or 1-butanol.

9. The soldering method according to claim 1, wherein the solder melting step fills inert gas such as nitrogen in an atmosphere of the joint unit.

10. The soldering method according to claim 1, wherein the solder melting step mixes reducing gas containing hydrogen gas or chlorine gas into the inert gas filled in the atmosphere of the joint unit.

11. The soldering method according to claim 1, wherein the solder melting step irradiates light energy or thermal energy near the joint units of the work and pre-heats the work itself immediately before the laser beam irradiation for melting the solder ball.

12. The soldering method according to claim 1, wherein the solder melting step irradiates a laser beam from a semiconductor laser on a rear surface of the work and pre-heats the work immediately before melting a solder ball by the laser beam from the semiconductor laser.

13. The soldering method according to any one of claims 1 to 3, wherein the solder ball is a low-melting-point solder.

14. The soldering method according to claim 13, wherein the low-melting-point solder is a low-melting-point lead-free solder containing Sn-57Bi, Sn-56Bi-1Ag or Sn-52In.

15. The soldering method according to any one of claims 1 to 3, wherein the work is a suspension mounting a slider thereon, and a pad formed in the suspension and a pad formed in the slider are electrically jointed.

16. A soldering apparatus comprising:
a solder ball deforming unit for mechanically deforming a ball to break an oxide film of a surface thereof and to expose a nonoxide surface; and
a solder melting unit for heating and melting a deformed solder ball through irradiation of light energy in a state where the deformed solder ball is mounted on joint units of a loaded work.

17. The soldering apparatus according to claim 16, wherein the solder ball deforming unit mechanically deforms the solder ball to form contact surfaces in contact with joint surfaces of the joint units.

18. The soldering apparatus according to claim 16, wherein the solder ball deforming unit mechanically deforms the solder ball to form at least two orthogonal contact surfaces in contact with the joint surfaces of the joint units.

19. The soldering apparatus according to claim 16, wherein the solder ball deforming unit comprises:
a first deforming unit of sandwiching and deforming a solder ball from both sides thereof to process the same into a tire shape; and
a second deforming unit of deforming in a direction orthogonal to the processing direction in the first deforming step to form two orthogonal contact surfaces in contact with the joint surfaces of the joint units.

20. The soldering apparatus according to claim 16, wherein an applying unit for applying a tacking agent on joint units of a loaded work is provided at the front stage of the solder ball deforming unit.
